(19) United States
(12) Patent Application Publication
(10) Pub. No.: US 2009/0134613 A1
(43) Pub. Date: May 28, 2009

(54) Hanging Strap

(76) Inventors: Matthias Eber, Kulmbach (DE); Michael Hilbert, Kupferberg (DE)

Correspondence Address: COLLARD & ROE, P.C., 1077 NORTHERN BOULEVARD, ROSLYN, NY, 11576, US

(21) Appl. No.: 12/225,004

(22) PCT Filed: Dec. 19, 2006
(86) PCT No.: PCT/EP2006/069931

§ 371 Date: Sep. 11, 2008

(30) Foreign Application Priority Data
Mar. 29, 2006 (DE) 20 2006 005 138.4

(51) Int. Cl. B60R 21/02; B65D 25/28

(52) U.S. Cl. 280/748; 16/110.1

(57) ABSTRACT

The invention relates to a holding loop for installation into a person conveying means, having a fastening loop (1) for pulling onto a holding rod, and a gripping loop (2) for a person, the two loops comprising a strap or a flat band. The fastening loop (1) is formed by fixing the strap or band ends or the strap or band sections above and/or below the holding rod in a hollow connecting element which has at least two individual elements (3a, 3b), which are arranged in pairs, with upper edge zones (4a, 4b) and lower edge zones (5a, 5b) and a respective central surface part as the advertising surface. The strap or band ends or strap or band sections are fastened between the individual elements (3a, 3b). An advertisement carrier can be pushed into the cavity via a lateral insertion gap (10). This is also possible if protective coverings are arranged over the individual elements. Advertisement carriers fitted onto the outside of the individual elements can likewise be covered by protective coverings (8a, 8b) of this type.

The invention relates to a hanging strap for installation in a means of passenger transport, said hanging strap having a fastening strap for fitting onto a grab bar and a grab strap for a person, both comprising a strap or flat band.

Means of passenger transport in the sense of the invention are land, rail, road and water vehicles for transporting persons who can also stand in the vehicles, in particular buses, trams, ferries and other local public transport vehicles.

A hanging strap for private or public means of transport of related type is disclosed in DE-PS-865 000. The strap comprises a steel strap of equal width which is vulcanised. The straps are riveted to each other or to a connecting part. A similar construction is disclosed in DE 203 09 342 U1.

CH-PS-353 309 discloses a grab handle with clock for public means of transport, said grab handle having advertising texts or images which are visible from one or a plurality of sides and are mounted fixedly or movably. The grab handle is fastened by means of a strap to a grab bar. The handle is formed at the bottom side from the intermediate part. A similar handle is disclosed in design patent GB 302 00 58. A hanging strap for local public transport vehicles is further disclosed in DE 203 09 342 U1. This hanging strap is characterised in that the strap material and the outer jacket of the connecting part can be furnished with an advertising print or in that advertising prints can be inserted. The strap thus has a multi-layer design, wherein one of the layers forms the advertising material. A device for interchangeable advertising texts is further disclosed in AT-PS-181 537.

DE 20 2005 012 035 U1 discloses a hanging strap of a related type, in which the fastening strap and the grab strap are connected to each other by means of a coupling element formed from two half shells, said half shells having gudgeons which can be joined together and cooperate with corresponding latching means on the other half shell. The gudgeons which can be joined together engage in holes in the strap ends or strap segments. The half shells exceed the width of the strap only insubstantially.

The object of the present invention is to provide a connecting element for formation of a strap with a preferably large advertising surface whilst maintaining the looped strap principle, as this has established itself particularly on public means of transport as a safe means for passengers on buses or trains to hold on to while standing on these vehicles. Furthermore, the connecting elements are to be formed in such a way that they can be easily manufactured and also assembled and furnished with advertising media on-site.

The invention achieves this object by virtue of the design of the hanging strap in accordance with the teaching in claim 1.

Three alternatives are presented in claim 1, each of which provides individual laminar elements made of metal or plastic for fixing of the strap or band ends or the strap or band segments, said elements being formed in such a way that they have, on the inside, a hollow space at least for location of the strap or band ends or strap or band segments, as well as means for fixing of the same in the hollow space. If the hollow space is formed in such a way that an advertising medium can be placed behind the flat middle part of the individual elements, then the individual element is made of transparent plastic, at least in the flat middle part, and forms, together with the paired second individual element, an insertion gap on the side or has such an insertion gap, in order to allow the advertising medium to be inserted into the hollow space respectively in front of the strap or band on continuous strap segments. If the strap or band ends of the respective strap are fixed in the upper or lower edge region of the individual element—depending on the arrangement of the connecting element above or underneath the grab bar—then the advertising medium can be inserted directly into the hollow space and can be printed for example on both sides. In the other case, two advertising media are used. The advertising media can be made in known fashion from flat cardboard or plastic elements. If both of the individual elements are made of non-transparent plastic or metal, e.g. diecast aluminium, then the second alternative provides a flat middle part on the outside for mounting or attachment of an advertising medium. The latter can be protected by means of a protective cap made of transparent plastic which extends across the entire area of the individual element or only over the middle area and is clipped on. For this purpose, known lugs are moulded on which engage either in recesses in the edge region of the individual elements or in recesses on a correspondingly arranged protective cap on the other individual element. To a skilled person, many known solutions are available here in order to provide a simple means of engaging the protective cap on the individual elements. However, the protective cap can also form a hollow space with the outer surface of the individual element, into which hollow space an advertising medium can be inserted. In order to enable insertion, a gap can be provided between the surface of the individual element and the protective cap. The protective cap itself can however have a moulded gap on one side in order to enable insertion. In practice, this gap represents a vertical slit.

Advantageous developments of the inventive design are described in detail in the subclaims.

In one embodiment, the provided connecting element made of transparent plastic serves not only as a connecting part and fastening part for the fastening strap and the grab strap, but in particular also as a flat carrier for advertising media, for example a printed cardboard card or a plastic card, and is made in accordance with the invention from two individual elements. These plastic parts are manufactured in an injection moulding tool. Through the arrangement of moulded connecting sleeves and latching elements, all of the parts can be manufactured symmetrically and the same in the process. The parts can then be latched to each other by rotating the central surface axis through 180°. Here, sleeve appendages engage in or over the other sleeve appendages of the second parts, so that screws or rivets can be inserted through these in order to securely join both parts to each other. In the process, the sleeves serve at the same time as pull relief for the straps. The straps have holes in this region by means of which they are placed onto the sleeves. In addition, the strap ends are connected to each other by means of the inserted screws and/or rivets. A latching connection can also be used and offers the required safety.

Instead of two sleeve connections, one sleeve and one gudgeon can also be provided. In the process, the lengths of the sleeves are chosen so that they reach fully through the holes in the strap ends. In this embodiment, no additional screws or rivets need to be provided for securing. The latched connection between the latching elements provided in the edge regions connects the two parts. The transfer of force from the straps to the joining connecting element is effected by means of the sleeve/gudgeon connection.

It can be seen that, practically with the same parts, advertising areas can be made available with simple means. However, the flat middle parts are arranged at a distance to each other so that the advertising medium can be inserted through an opening gap on the side.

It is however also possible for the individual elements to be formed having a slightly curved shape so that a hollow space is provided between them. The hanging straps then be formed in a continuous design. The fastening is performed in the same manner. In the case of the hollow embodiment, it must be ensured that guides are provided on the inner surfaces of the middle areas in order to allow advertising media to be inserted through an opening slit on the side. The middle segment of the strap is then positioned between the two advertising media and is not visible. Straps of a known type are used as the hanging strap, said straps preferably being coated with plastic.

Alternatively, frames can be additionally arranged on the outside on the flat middle parts, into which frames the advertising media can be engaged. Furthermore, covers can also be attached which are transparent and cover and press on the advertising media positioned on the outside.

It is sufficiently known that, particularly on grab bars of buses, the fastening straps can slip to one side, and that unsatisfactory means of securing the straps against being displaced to one side is only provided by virtue of the properties of the inside of the coating of the straps and by virtue of the tensile force acting downward on the hanging strap. In order to improve this, according to the invention the hanging strap is mounted on a mounting body made of metal or plastic, which is adhesively bonded or screwed to the grab bar or has a non-slip inside coating.

This mounting body is practically formed in a half or quarter shell form and has lateral limiting beads on the side project upwards, so that the fastening strap is held and secured laterally. This mounting body also allows the individual hanging straps to be mounted at intervals on a longer grab bar.

In the case where the connecting element is mounted above the grab bar, by virtue of the design of the individual elements in the inner region and by means of rotating the strap or band ends it is possible to adjust the angle around a vertical axis in relation to the grab bar axis so that the advertising medium can also be viewed from passengers on seats, for example on a bus, which are located further away.

The invention will be explained in more detail in the following with reference to the embodiments shown in the figures,

in which:

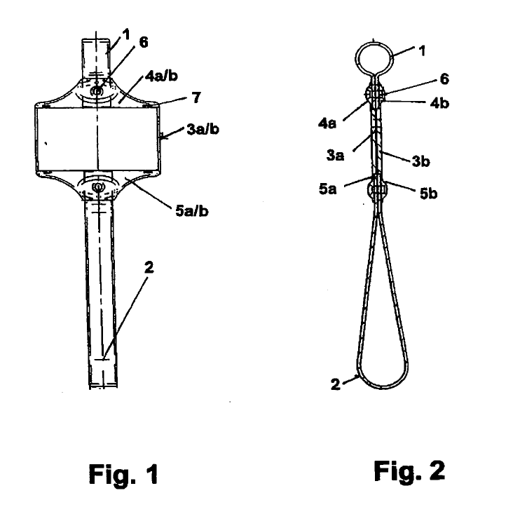

FIG. 1 shows a hanging strap according to the invention having one connecting element which comprises two transparent flat plastic elements,

FIG. 2 shows a cross-sectional view through the middle of the hanging strap according to FIG. 1,

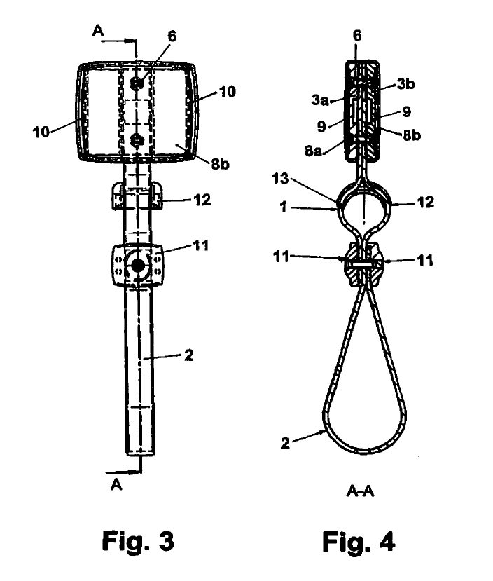

FIG. 3 shows an example of a hanging strap having one connecting element above the grab bar with protective caps positioned in place,

FIG. 4 shows a cross-section taken according to the line A-A longitudinally through the hanging strap according to FIG. 3,

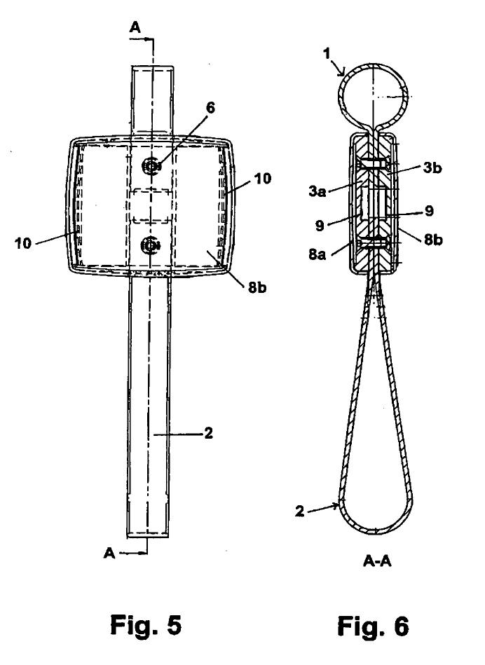

FIG. 5 shows an example of a hanging strap having one connecting element underneath the grab bar as a variant of FIG. 3 and

FIG. 6 shows a cross-section taken according to the line A-A longitudinally along the hanging strap according to FIG. 5,

The hanging strap comprises a fastening strap 1 and a grab strap 2. The fastening strap 1 has a diameter which approximately corresponds to the diameter of the grab bar in the means of passenger transport, e.g. bus. The fastening strap 1 comprises a strap material which is coated in plastic and cut to a length such that it ends between the upper edge regions 4a, 4b of the connecting element. The plastic element comprises two individual elements 3a, 3b made of transparent plastic, said two individual elements being engaged with each other and/or capable of being screwed or riveted to each other. The flat middle part is formed as an advertising area. The individual elements 3a, 3b are made of transparent plastic or can also be manufactured for example using a 1-component injection moulding technique, wherein the upper and lower edge regions 4a, 4b and 5a, 5b comprise coloured plastic and the middle area comprises transparent plastic. The two parts are of an identical and symmetrical design and have moulded sleeves 6, which are inserted inside each other through a 180° rotation or can also have latching elements 7 for engagement. Screws or rivets are inserted in the sleeves 6 for securing. The sleeves 6 engage in holes in the ends of the fastening strap 1 and in the ends of the grab strap 2 and secure them, so that the entire holding force is transferred onto and via the connecting element onto the grab bar which is not shown. The two flat middle parts of the individual elements 3a, 3b are arranged with a small spacing to each other, so that a gap is formed on at least one side, through which gap the advertising medium can be inserted. In this embodiment, a plastic or metal clamp can also be provided instead of the fastening strap 1, said clamp also being fixed with its ends between the two individual elements.

FIGS. 3 and 4 show a variant. This variant also comprises one fastening strap 1 and one grab strap 2, which are both separated from each other by means of a coupling element 11 of known type. The coupling element 11 comprises two half shell bodies made of metal or plastic, which join the two strap or band segments which are to be connected to each other. For this purpose a screw is screwed through the material of the straps or bands or inserted through a hole and held securely in the two half shells, which also encompass the strap laterally. In this embodiment, the fastening strap is formed by virtue of the fact that the connecting element, which comprises the two individual elements 3a and 3b, is attached above the grab bar, which is not shown. In a bus or a tram coach there is generally a larger distance between the grab bar and the roof of the vehicle which permits the attachment in this way. In this embodiment, the two strap ends are inserted in a central channel between the individual elements 3a and 3b. The two individual elements have sleeves 6 which engage in holes and/or locating holes in the strap ends. The two individual elements 3a and 3b can then be connected to each other by means of screws or rivets. The individual elements 3a and 3b can be made of metal or plastic and are non-transparent in this embodiment. On the outer surfaces, the individual elements 3a and 3b have a middle segment which substantially extends across the entire outer surface. An advertising medium can be attached to this middle segment. In the embodiment shown, a protective cover 8a and 8b is clipped on from both sides, forming a hollow space 9 together with the respective outer side of each individual element 3a and 3b. The advertising medium can be inserted into this hollow space via an insertion gap 10 provided on the side in the protective cover 8a and 8b. In the case where the individual elements 3a and 3b are made of transparent plastic, the advertising medium covers the fastening of the strap ends and the guide channel which can be seen in FIG. 3. The embodiment further shows that the fastening strap is mounted on a half shell-shaped mounting body, and that the latter is equipped with an inner surface furnished with a layer of adhesive 13 or a non-slip coating which acts on the grab bar. The mounting body 12 has bead-shaped lateral restrictors for fixing the fastening strap 1.

A further example is shown in FIGS. 5 and 6. The connecting element is arranged underneath the grab bar for formation and separation of the fastening strap 1 from the grab strap 2. The connecting element has the same structure as is shown in the embodiment according to FIGS. 3 and 4. Reference is therefore made at this point to be description provided above. It can be seen from FIG. 6 that fastening strap 1 and grab strap 2 can be formed either from separate straps or as an endless, looped strap. Between the two individual elements 3a, 3b the strap segments are held with screws or rivets which are inserted in bores or holes in the individual elements 3a, 3b and the strap segments.

It can be seen from the embodiments that the connecting elements which are capable of being furnished with advertising media can be attached above or underneath the grab bars. Given appropriate height positioning of the grab bar, advertising media can therefore be positioned above and underneath the latter.

### LIST OF REFERENCE NUMBERS

1 Fastening strap
2 Grab strap
3a Individual element
3b Individual element
4a Upper edge region
4b Upper edge region
5a Lower edge region
5b Lower edge region
6 Sleeve
7 Latching means
8a Protective cover
8b Protective cover
9 Hollow space
10 Insertion gap
11 Coupling element
12 Mounting body
13 Layer of adhesive

1. Hanging strap for installation in a means of passenger transport, having one fastening strap (1) for attachment to a grab bar and one grab strap (2) for a person, both comprising a strap or flat band, wherein the fastening strap (1) is formed by fixing the strap or band end or the strap or belt segments above and/or underneath the grab bar in a hollow connecting element, said hanging strap having at least two substantially flat individual elements (3a, 3b) arranged in pairs having upper (4a, 4b) and lower edge regions (5a, 5b) and one flat middle part as an advertising surface, said at least two substantially flat individual elements being connected to each other and immovably encompassing the strap or band ends or segments, wherein the individual elements (3a, 3b) extend at a distance to each other at least in the region of their flat middle parts and form or have at least one lateral insertion gap for inserting a flat advertising medium and are made of transparent plastic or transparent protective covers (81, 8b) are attached at 25 the outer sides of the individual elements, said transparent protective covers, at least in the region of the flat middle parts of the individual elements (3a, 3b), forming with these a flat hollow space (9) and at least one lateral insertion gap for inserting a flat advertising medium or having an insertion gap (10) or covering on the outside the flat middle parts for insertable advertising media on the individual elements (3a, 3b).

2. Hanging strap according to claim 1, wherein the individual elements (3a, 3b) are connected to each other by means of a nonpositive or positive connection and clamp the strap or band ends or segments.

3. Hanging strap according to claim 2, wherein the individual elements (3a, 3b) are connected to each other by means of latching elements (7) and/or screws and/or rivets, wherein the screws and/or rivets are guided through holes in the strap or band ends or segments.

4. Hanging strap according to claim 3, wherein latching elements (7) and/or screws and/or rivets for establishing the nonpositive and positive connection are provided in the edge regions (4a, 4b, 5a, 5b) or that holes are provided in the edge regions (4a, 4b, 5a, Sb) to locate them.

5. Hanging strap according to claim 2, wherein the latching elements (7) and/or screws and/or rivets are capable of being introduced through the sleeves protruding at the opposing insides of the individual elements, onto which the holes on the strap or band ends or segments can be placed.

6. Hanging strap according to claim 3, wherein a plurality of latching elements (7) are provided in the edge regions (4a, 4b; 5a, Sb), which latching elements engage with each other when the two individual elements (3a, 3b) are pressed together.

7. Hanging strap according to claim 1, wherein the individual elements (3a, 3b) form an interior hollow space of sufficient size so that the fastening strap (1) and the hanging strap (2) can be formed as a single part and inserted between the upper edge regions (4a, 4b) and are fixed in the lower edge regions (5a, 5b) and extend through the middle longitudinal axis, and in that, on the insides of the individual elements (3a, 3b), guides are provided for the advertising media which are capable of being inserted laterally into the slit, or that fields are provided which are limited by means of frames on the outside, into which the advertising media can be pressed.

8. Hanging strap according to claim 1, wherein the individual elements (3a, 3b) are formed with identical contours and capable of being connected by means of a 180°-rotation around the axis of the flat middle part, wherein moulded sleeves which engage in a looped strap are provided in the region of the holes, onto which the holes in the fastening straps and grab straps (1, 2) can be placed.

9. Hanging strap according to claim 1, wherein the flat middle parts have a width of 60 to 140 mm and a height of 40 to 140 mm.

10. Hanging strap according to claim 1, wherein the connecting element is arranged underneath the grab bar and the fastening strap (1) is attached on the upper side and the grab strap (2) is attached on the underside in protruding fashion.

11. Hanging strap according to claim 1, wherein the ends of the strap or band are clamped by means of the connecting element above the grab bar for formation of the looped fastening strap (1), and that, underneath the grab bar, a coupling element (11) connects the two strap or band ends or segments with each other for limitation of the opening of the fastening strap (1)

12. Hanging strap according to claim 1, wherein the fastening strap (1) is inserted in a U-shaped mounting body (12) for lateral fixing to the grab bar, said mounting body overlapping the grab bar at least at the top and being held securely against the latter to prevent lateral displacement.

13. Hanging strap according to claim 12, wherein the mounting body (12) is made of metal or plastic and is adhesively bonded or screwed to the grab bar or abuts against the grab bar by means of a non-slip internal coating (13).

14. Hanging strap according to claim 1, wherein the individual elements (3a, 3b) are made of metal or plastic.

15. Hanging strap according to claim 1, wherein if a connecting element is attached above the grab bar, the individual elements (3a, 3b) and strap or band ends are formed in such a way that the connecting element extends at a certain angle around a vertical axis in relation to the longitudinal axis of the grab bar.
